(19) United States
(12) Patent Application Publication
(10) Pub. No.: US 2016/0250732 A1
(43) Pub. Date: Sep. 1, 2016

(54) SKATE BLADE HOLDER TOOL WITH ADJUSTABLE-SIZE BLADE RETENTION

(71) Applicant: Velasa Sports, Inc., Acton, MA (US)

(72) Inventors: Russell K. Layton, JR., Acton, MA (US); Daniel A. Beaudet, Lexington, MA (US); Ivan D. Goryachev, Nashua, NH (US)

(21) Appl. No.: 14/632,868

(22) Filed: Feb. 26, 2015

(51) Int. Cl. B24B 3/00; B25B 5/02

(52) U.S. Cl. CPC B24B 3/003; B25B 5/02

(57) ABSTRACT

A blade holder tool for inserting a loose skate blade into a sharpener unit for sharpening includes blade-engaging features that engage blade retention features of the skate blade, and a spacing component providing user-controlled variable spacing of the blade-engaging features to hold skate blades across a range of sizes. The tool may include an elongated tool body having a bottom portion configured to receive the skate blade, the tool body supporting the blade-engaging features and spacing component. The blade-engaging features may include a pair of biased-closed housing members engaging the retention features of the skate blade, and a separate tool body may not be required. A spring or elastic member is connected between housing members to bias closed the blade-engaging features. Mechanical and/or graphical features may be used for positioning and orienting the skate blade to the blade holder tool, and/or the blade holder tool to the sharpener unit.

### BACKGROUND

The present invention is related to the field of skate blade sharpening systems for sharpening the blades of ice skates.

A variety of sharpening systems are known for sharpening skate blades. Historically, sharpening has been done on “complete” skates, i.e., skates with blades that are permanently or semi-permanently attached. For example, the blade may be secured to a blade holder portion (typically molded plastic), which is mounted to an upper skate boot. Sharpening systems have been designed accordingly. In particular, the systems have been designed with an assumption that a user can grasp and manipulate a skate boot and/or blade holder portion as needed to bring the skate blade into a position to be clamped and retained during sharpening.

More recently there is increasing use of skates with user-removable skate blades, enabling a skater to easily swap blades as might be desired for consistent performance. The removable blades, also referred to as “loose” blades herein, are long and narrow, measuring perhaps one inch in height when the blade is oriented horizontally as it is in use. The increasing use of such removable blades presents new challenges with respect to blade sharpening. First is a functional challenge—the need to sharpen a loose blade rather than a blade attached to a skate. More generally, players at all levels, including those who might not own multiple pairs of skates, may prefer to own several pairs of blades and swap them as often as they need to. This increases demand for sharpening, including at sub-professional levels where players are becoming more accustomed to always having consistent edges (i.e. sharp) when playing. Thus, a second challenge has an economic component—to provide quality sharpening at a lower cost to make it more accessible to a larger number of players. Cost requirements of course translate to technical requirements in the sense of favoring technical solutions that are relatively simple, accessible, and of low cost to manufacture and maintain.

### SUMMARY

The present invention is motivated by the above and other challenges of sharpening loose skate blades, as described further herein. Additional aspects of the challenges are first elaborated, and then certain important features that address these challenges are described.

One challenge of sharpening a loose skate blade is that a user may not be able to easily, safely, and/or accurately load a loose skate blade into a skate sharpener for sharpening. Difficulty arises in part due to the short height of the blade and the relative lack of area for a user to grasp the blade when loading it into the clamp of a sharpening system. For example, a user may pinch or otherwise injure his/her fingers when securing a loose skate blade to a blade clamp. These challenges may be greater when using an automated, vertical mount configuration skate sharpener, an example of which is described herein. In these machines, the jaws that clamp the skate blade can be recessed below an upper slotted surface through which the blade passes during insertion and removal. The surface around the slot creates interference with the user's fingers when lowering the blade into the clamp. In some of these machines there also may not be any structure acting as a vertical stop for the blade during insertion. This lack of vertical stop increases the complexity of loading a loose blade. For example, a loose blade might easily be dropped into the enclosure of the skate sharpener, which might require that the sharpener be disassembled or opened to retrieve the loose skate blade.

Other challenges relate to the quality of sharpening as affected by inaccurate positioning of the skate blade. It is important that the skate blade be positioned and oriented correctly for best sharpening. Details of these issues are described further below. Existing solutions are seen to be either limited or even wholly inadequate at addressing this need for accurate positioning and orienting of the skate blade. Additionally, it is important that a new solution involve one tool with a universal quality so as to work with skate blades of various sizes.

A blade holder tool is disclosed for a user to hold a skate blade and insert the skate blade into a sharpener unit for a sharpening operation, where the skate blade is a user-removable skate blade having retention features configured to engage a user-controlled blade retention mechanism of a skate to secure the skate blade in the skate, and the retention features of the skate blade have a blade-size-specific spacing in a spacing range for skate blades across a range of blade sizes.

The blade holder tool includes blade-engaging features configured to engage the retention features of the skate blade to hold the skate blade at a bottom portion of the blade holder tool, and a spacing component configured to provide user-controlled variable spacing of the blade-engaging features across the spacing range to hold skate blades across the range of sizes.

In one embodiment, the blade holder tool includes an elongated tool body having a bottom portion configured to receive the skate blade to be held by the blade holder tool, and the blade-engaging features and spacing component are supported by the tool body. The blade-engaging features move symmetrically in opposite axis directions about a center location to provide user-controlled variable spacing of the blade-engaging features. In one example, the blade-engaging features include a pair of biased-closed sliding members (e.g., spring-loaded) having respective rack portions engaging a rotating pinion gear mounted to the tool body.

In another embodiment, the blade holder tool employs blade-engaging features including a pair of biased-closed housing members each engaging a respective one of the retention features of the skate blade. In this arrangement, a separate tool body may not be required. In a further embodiment of this type, the blade holder tool includes a spring or elastic member connected between the housing members to bias closed the blade-engaging features relative to each other.

In other aspects, the blade holder tool may include features for positioning and orienting the skate blade to the blade holder tool, and/or for positioning and orienting the blade holder tool to the sharpener unit. The features may include mechanical features and/or graphical features that are formed or applied, e.g., using labels.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a perspective view of a skate sharpening system;

FIG. 2 is a schematic depiction of a grinding wheel contacting a skate blade during sharpening;

FIG. 3 is a front elevation view of a sharpening system;

FIG. 4 is a perspective view of a skate blade clamp;

FIG. 5 is a bottom view of a slot cover;

FIG. 6 is a diagram an ice skate;

FIG. 7 is a diagram of a loose skate blade;

FIGS. 8 and 9 are perspective views of a blade holder tool with attached skate blade;

FIG. 10 is a perspective view of the underside of a blade holder tool;

FIG. 11 is a perspective view of blade-engaging features within a body of the blade holder tool;

FIG. 12 is an elevation view of blade-engaging features of a blade holder tool holding a skate blade with proper orientation;

FIG. 13 is an elevation view of blade-engaging features of a blade holder tool not engaging a skate blade with improper orientation;

FIG. 14 is an elevation view of blade-engaging features of a blade holder tool holding a smaller skate blade;

FIG. 15 is a perspective view of the blade holder tool holding a skate blade;

FIG. 16 is a top-down view of clamp jaws of a sharpener unit;

FIG. 17 is a bottom-up view of a skate blade with attached blade holder retained by clamp jaws;

FIG. 18 is a view of an upper part of a sharpener unit with blade holder tool present;

FIG. 19 is a perspective view of a blade holder tool according to another embodiment;

FIG. 20 is an elevation view of the blade holder of FIG. 19;

FIGS. 21-22 are detailed views of blade-engaging members of the blade holder of FIG. 19;

FIGS. 23-28 are views of an alternative embodiment of a skate blade holder tool; and

FIG. 29 is a view of an alternative loose skate blade.

### DETAILED DESCRIPTION

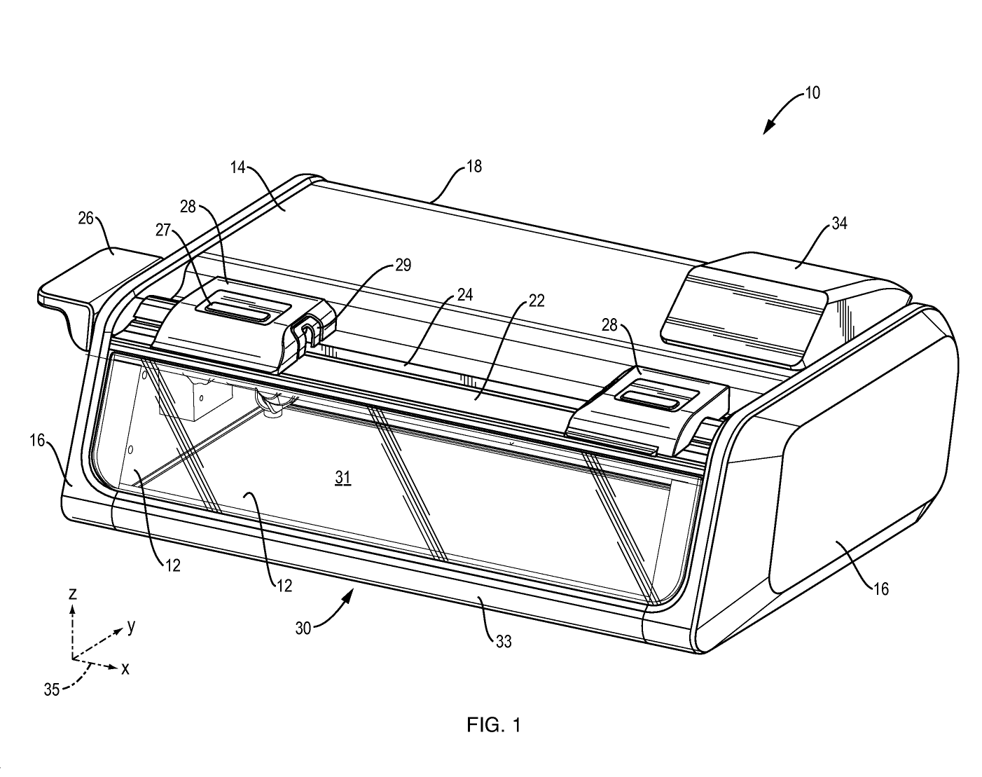

FIG. 1 is a perspective view of a skate sharpener 10, also referred to as a “sharpener unit”, used to sharpen the blades of ice skates. It has a box-like housing with structural elements including a rigid frame 12 (bottom visible in FIG. 1) and a rigid chassis 14. Attached components include end caps 16 and a rear cover 18. The chassis 14 includes a front platform portion 22, also referred to as “platform” 22 herein. The platform 22 includes an elongated slot 24 for receiving the blade of an ice skate for sharpening, and the blade is retained by clamp jaws (not shown) on the underside of the platform 22 which are actuated by a mechanism including a clamp paddle 26. Disposed on the platform 22 are slot covers or “scoops” 28 at respective ends of the slot 24, each including a respective bumper 29 serving to sense contact with a skate blade holder. An outward-opening door 30 having a glass panel 31 and lower hinge portion 33 extends across a front opening. A user interface display panel 34 is disposed at top right on the chassis 14. The skate sharpener 10 also includes a control module or controller, which is not visible in FIG. 1 and may be located, for example, inside of the rear cover 18. Further mechanical and electrical details are provided below.

FIG. 1 also shows a coordinate system 35 for references to spatial directions herein. The X direction is left-to-right, the Y direction front-to-back, and the Z direction bottom-to-top with respect to the skate sharpener 10 in the upright, front-facing orientation of FIG. 1. This coordinate system also defines an X-Y plane (horizontal), X-Z plane (vertical and left-to-right), and Y-Z plane (vertical and front-to-back). Using this coordinate system 35, the slot 24 extends in the X direction and the skate blade is clamped in an X-Z plane during sharpening as described more below.

While this description includes a sharpening system such as that of FIG. 1 that operates in an automated fashion, the need to manipulate and properly load a loose skate blade in a sharpening system is relatively independent of the type of sharpener. Thus, aspects of the present disclosure are also applicable to manual sharpening systems that lack automated control of a sharpening operation.

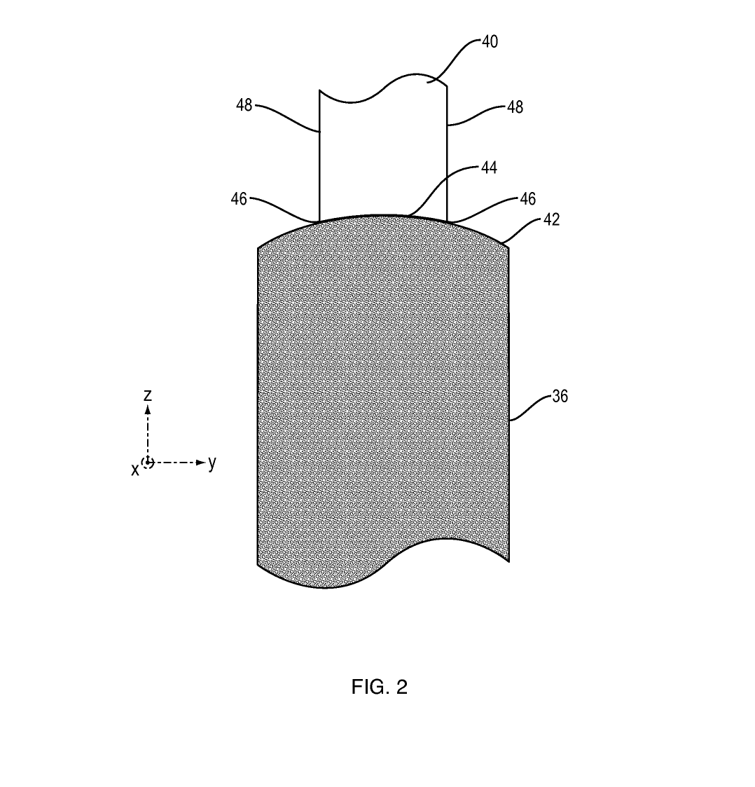

FIG. 2 depicts how a skate blade is sharpened. This is a schematic edge-on view of a lower portion of a skate blade 40 in contact with an outer edge of a grinding wheel 36. With reference to the coordinate system 35, this is a view in the X direction. As shown, the grinding wheel 36 has a convex rounded grinding edge 42. In practice the grinding edge 42 may be generally hemispherical. The grinding wheel 36 rotates in the plane of the blade 40 (X-Z plane, into the paper in FIG. 2), thereby imparting a corresponding concave rounded shape to a lower face 44 of the skate blade 40. Two acute edges 46 are formed at the intersection of the curved lower face 44 and the respective sides 48 of the blade 40. As material is removed, a clean and precise arcuate shape is restored to the lower face 44, including sharper edges 46. In practice, the radius of curvature of the lower face 44 is in the general range of ⅜″ to 1″, with one generally preferred radius being ½″.

It will be appreciated that the disclosed methods and apparatus may be used with other blade profiles, including flat and V-shaped, for example.

Returning to FIG. 1, basic operation with a complete skate is as follows. The user clamps the blade 40 of a skate in the slot 24 and slides the slot covers 28 inwardly until the bumpers 29 are engaged by a blade holder part of the skate. Each bumper 29 actuates a limit switch within the respective slot cover 28, so that the engagement is sensed by the controller to enable sharpening to proceed. The user then interacts with a user interface presented on the display panel 34 to initiate a sharpening operation. Subject to certain conditions as described more below, control circuitry of the control unit automatically operates both a grinding motor to spin a grinding wheel and a separate carriage motor (described briefly below) to move the rotating grinding wheel back and forth along the lower face of the skate blade a desired number of times. Upon completion of a desired number of passes, the control unit stops both the rotation and back-and-forth motion of the wheel 36, and the user unclamps and removes the skate blade from the sharpener 10.

The above operation may also be used with bare removable skate blades of the type known in the art. In this case a skate blade holder is used to enable a user to position the bare blade in the slot 24 for clamping and to engage the bumpers 29 of the slot covers 28 to permit operation. Further below is an extensive description of such skate blade holders and their use.

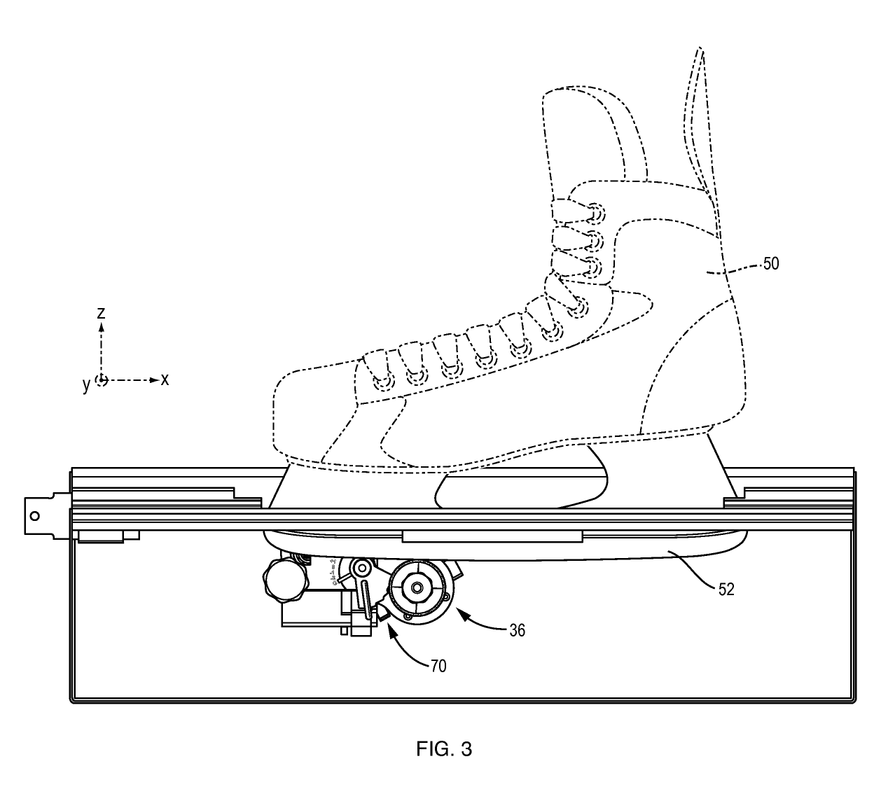

FIG. 3 is a front view illustrating the sharpening operation for a complete skate as described above. A skate 50 is present and its blade 52 is clamped into a sharpening position in which the lower portion of the blade 52 extends downward through the slot 24 (FIG. 1) into the interior of the sharpener 10. FIG. 3 shows an internal carriage assembly 70 and grinding wheel 36 in the middle of a pass. It can be seen that the grinding wheel 36 just touches the lower edge of the blade 52, and it follows the profile of the blade 52 throughout each pass. Generally multiple passes are used in a sharpening operation for a given blade 52, with the number of passes being determined by the amount of material removal that is necessary to achieve desired sharpness. The sharpener may use both left-to-right and right-to-left passes in sequence, i.e., the grinding wheel 36 travels back and forth in contact with the blade 52 in both directions. Assuming a single home position at one end, in practice each sharpening operation may have a number of two-pass cycles, each including a pass in one direction and a pass in the opposite direction. In alternative embodiments sharpening may occur in only one direction, i.e., the grinding wheel 36 is in contact with the skate blade 52 only for passes in one direction, which alternate with non-sharpening return passes in the other direction.

FIG. 4 shows the underside of the chassis 14. It includes a skate blade clamping mechanism whose major components are a pair of clamp jaws 90, specifically a front jaw 90-F and a rear jaw 90-R; a pull rod fork 92; a clamp cylinder 94; and a cam 96 at the underside of the clamp paddle 26 that rotates therewith. The clamp cylinder 94 is retained by a bracket 98. Also shown is a jaw guard 100. The clamp cylinder 94 has a pull rod 102 connected to the pull rod fork 92 and an internal spring-piston arrangement that actuates the pull rod 102 and thus the jaws 90 via the pull rod fork 92.

As shown, the jaws 90 each include angled slots 104, and in the slots 104 are arranged rectangular guide blocks 106, 107 that retain the jaws 90 at the underside of the platform 22 with spacing to permit the jaws 90 to slide in the long direction of the slots 104.

When the clamp paddle 26 is in the position shown in both FIG. 4 and FIG. 1, i.e., extending horizontally away from the platform 22, the lobe of the cam 96 does not engage the internal piston of the clamp cylinder 94, and the action of the internal spring is to retract the pull rod 102 (toward the left in FIG. 4) so that the jaws 90 are brought toward each other by action of the angled slots 104 and guide blocks 106, 107. This is a referred to as a “closed” position, in which the jaws 90 are either just touching each other or are only slightly spaced apart, less than the width of the thinnest skate blade to be sharpened. Because this position is created by the spring alone, it is referred to as a “biased closed” position.

When a skate blade is to be clamped for sharpening, a user rotates the clamp paddle 26 to open the jaws 90. Referring to FIG. 1, the user pushes downward on the outer part of the clamp paddle 26. In FIG. 4, the clamp handle 26 rotates out of the page, rotating the cam 96 accordingly and causing it to push against the piston within the clamp cylinder 94. This force works against the spring bias to extend the pull rod 102 and push on the jaws 90, causing them to move away from each other by action of the angled slots 104 and guide blocks 106, 107. The space between the jaws in the open position is wider than the widest skate blade to be sharpened. The cam 96 and head of the piston may be co-configured to establish a detent with the jaws in the fully open position. The skate blade is then inserted through the slot 24 between the jaws 90, and the user then rotates the clamp paddle 26 upwardly (FIG. 1) to close the jaws 90 on the skate blade. It will be appreciated that the front jaw 90-F automatically rotates as necessary to close snugly against the skate blade with balanced force across the length of the jaws 90. In the absence of this rotating feature, any imperfection in alignment of the jaws 90 could create undesirable binding and/or rotational skewing of the skate blade, adversely affecting sharpening operation.

The jaw guard 100 protects against the possibility of contact between the grinding wheel 36 and the jaws 90. If the skate sharpener 10 were to somehow be operated without a skate blade present, then without the jaw guard 100 the wheel 36 would move across the jaws 90 at its upper vertical limit position, potentially damaging the grinding wheel 36 and/or the jaws 90. This is prevented by the jaw guard 100, which would be encountered by a spindle (not shown) and keep the grinding wheel 36 in a more downward position safely away from the jaws 90.

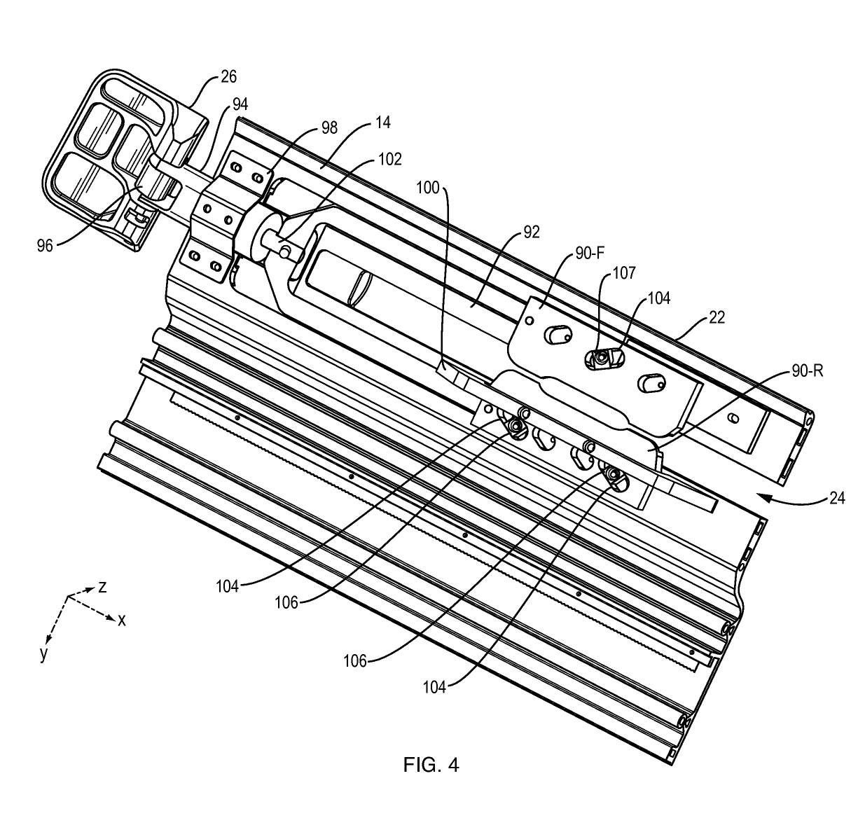

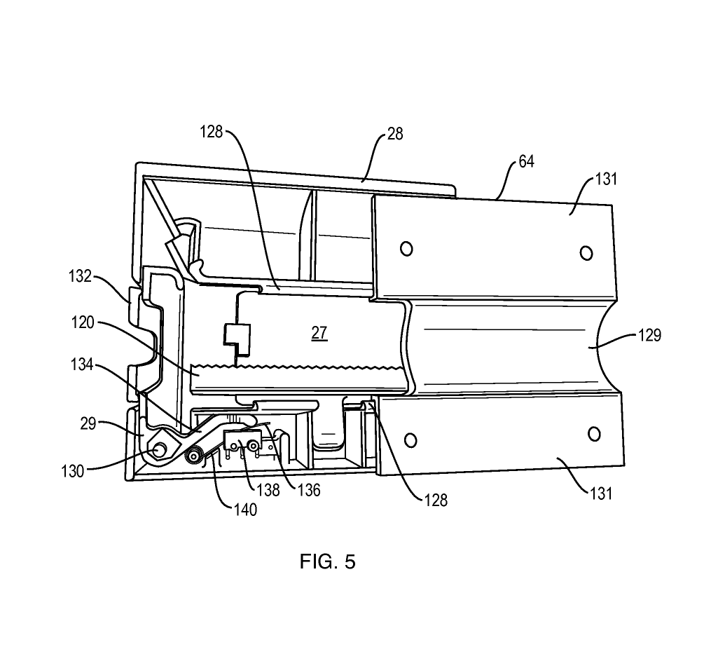

FIG. 5 is a bottom view of a slot cover 28 and an arch 64 on which it is captured, the arch 64 being attached to the chassis 14 (FIG. 1). The bottom of the button 27 is visible, including a rack 120 that moves in and out of the page in this view when the button 27 is operated as described above. The slot cover 28 is retained on the arch 64 by a latch-like rail mechanism including inner edges 128 of the slot cover 28 that fit within corresponding elongated grooves on the upper surface of the arch 64 where the central rounded portion 129 meets the lateral flat portions 131.

FIG. 5 shows the arch 64 as a distinct mechanical component, which in the illustrated embodiment is attached to platform portion 22 of the chassis 14. In alternative embodiments, the platform portion 22 may itself be formed (e.g., through molding, machining, etc.) to include arch-like portions serving the same purpose of retaining the slot covers 28.

In the illustrated embodiment, the bumper 29 is attached to the body of the slot cover 28 (at lower left corner in this view). The attachment is with a pin or similar fastener 130 that permits the bumper 29 to rotate. A face portion 132 contacts a skate blade holder in operation as described above (FIG. 1 and related description). Another portion 134 extends to an actuation lever 136 of a limit switch 138. The bumper 29 is biased (counterclockwise in this view) by a spring 140. The limit switch 138 is wired to the above-mentioned controller (not shown) to enable the controller to sense its electrical state (open or closed). The wires are omitted in FIG. 5 for ease of illustration.

In operation, the limit switch 138 is electrically open and mechanically open by default, due to the mechanical biasing action of the spring 140. When the face portion 132 of the bumper 29 is depressed, the bumper 29 rotates (clockwise in this view) and the arm 134 depresses the limit switch lever 136, electrically closing and mechanically closing the limit switch 138. The state of the limit switch 138 as open or closed is sensed by the controller. In one embodiment, sharpening operation is permitted only when the limit switch 138 is sensed as closed, which normally occurs when a skate blade is clamped in position and the slot covers 28 have been moved inward to contact the skate blade holder. In these operating positions the slot covers 28 cover the outer ends of the slot 24 that would otherwise be open. This prevents the introduction of any objects through the outer ends of the slot 24, where such objects might harmfully contact the rotating grinding wheel 36 as it moves along the slot 24 during a sharpening operation. If the limit switch 138 of either slot cover 28 is sensed as electrically open or mechanically open, which normally occurs when either a skate or skate blade holder is not present or both slot covers 28 have not been moved inward to their operating positions, the controller prevents sharpening operation, i.e., provides no electrical drive to the grinding wheel motor and the carriage motor. With these motors not rotating, it is safer to introduce objects (such as a skate blade during mounting, for example) into the slot 24.

There are various alternatives to the configuration described above. An alternative to the bumper 29 may be a piston-like mechanism that moves linearly to actuate a switch, instead of rotating about a fixed pivot point as in the above. More generally, the slot covers 28 may include respective mechanical members that translate mechanical contact with the skate blade holder to actuation of a switch or similar sensor. Additionally, it is not necessary to use a limit switch with an actuation lever—in an alternative arrangement the bumper 29 (or analogous member) may directly push on the button of a limit switch. Also, in some embodiments a separate spring 140 may not be required. It may be possible to rely on the spring of a limit switch to provide a bias or return force. However, it may be desirable to use a separate spring to provide for adjustment of either/both the range of motion and actuation force of the bumper.

Regarding the limit switch 138, there may be different specifics in alternative embodiments. The key function is that contact with a skate toggle, both mechanically and electrically, the state of a switch or other sensor. In an alternative embodiment, a contactless sensor such as an optical emitter-detector pair could be used, with the skate or skate blade holder breaking the optical path to trigger the sensor.

In the illustrated embodiment the slot covers 28 are affixed and always present, but in an alternative embodiment they could be separate components that are placed and locked onto the ends of the skate or skate blade holder by the user prior to sharpening. Also, while in the illustrated embodiment the slot covers 28 move by sliding, they could alternatively move by rotating on a hinge, telescoping, or rolling out (like a breadbox or garage door). Certain details and alternatives are described more fully below.

As described above with reference to FIG. 3, the sharpener unit 10 may be used to sharpen the blades of “complete” skates, i.e., skates with blades that are removed either with difficulty or not at all. For example, the blade may be secured to a blade holder portion (typically molded plastic) which is mounted to an upper skate boot. Historically, the method to secure the blade to the blade holder portion has used fasteners that clamp or pull the blade into or against the blade holder portion. There are other configurations where the blade is molded into the blade holder portion and is not separable therefrom.

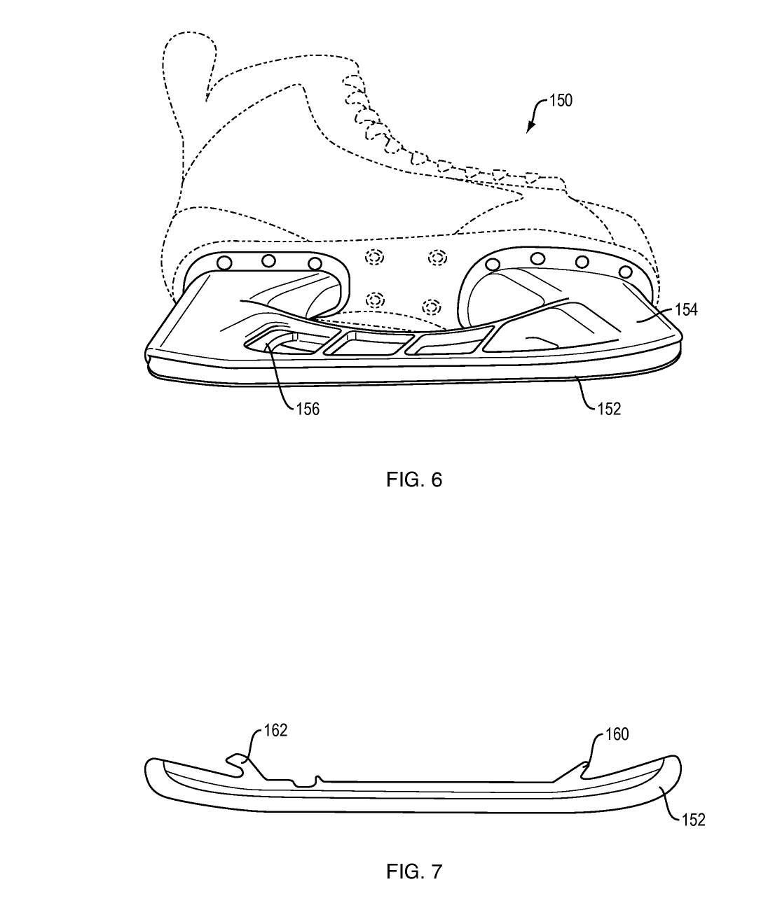

FIG. 6 shows a newer type of skate 150 in which the blade 152 is removable by a user (e.g., skater) from the holder portion 154 with very little difficulty, in some cases without requiring any tools. The blade 152 is retained in the holder portion 154 by retention mechanism including a user-actuated release button 156 in the heel area. The release button 156 includes a spring type feature biasing the release button 156 to a closed position in which an inserted blade 152 is retained. A user activates the release button 156 by applying a counteracting force to open the retention mechanism for blade insertion and removal.

FIG. 7 illustrates a skate blade 152 apart from the remainder of the skate 150, also referred to as a “loose” blade 152 herein. As shown, the blade 152 has front and rear upper protrusions 160, 162, which are also referred to as “blade retention features” or simply “retention features” herein. The front protrusion 160 is captured by a fixed crosspiece (not shown) inside the toe area of the skate blade holder 154, and the rear protrusion 162 is captured by the spring-loaded retention member inside the heel area (also not shown). To install the blade 152, a user places the front part into the toe area of the blade holder portion 154 (FIG. 6) and then pivots the rear part of the blade 152 into the heel area. The internal retention member allows entry of the rear protrusion 162 and then snaps back into place to capture the rear protrusion 162 and lock the blade 152 in place. To remove the blade 152, the user pulls back on the release button 156 to open the internal retention member, then performs the opposite motions on the blade 152—pivoting it downward away from the heel area, then pulling it out of the toe area.

One benefit of tool-less blade insertion/removal is that equipment managers, coaches, and players can easily swap out blades if desired while playing. Because of the ease of removing the blade, the blade can be swapped quickly during or after a skating session. Another advantage is that a player can keep one or more extra pairs of skate blades in his/her equipment bag, potentially reducing the frequency with which the player would need to visit an ice skate sharpener, and reducing the chances that a player will experience sharpening issues while traveling away from home to play.

The increasing use of removable blades such as blade 152 presents new challenges with respect to blade sharpening. First is a functional challenge—the need to sharpen a loose blade rather than a blade attached to a skate. More generally, players at all levels, including those who might not own multiple pairs of skates, may prefer to own several pairs of blades and swap them as often as they need to. This increases demand for sharpening, including at sub-professional levels where players are becoming more accustomed to always having sharp edges when playing.

Further with respect to the functional challenge—sharpening a loose skate blade—a user of a skate sharpening machine cannot easily and accurately load a loose skate blade into most skate sharpeners, specifically into their blade clamps. The blade clamp is the fixture that securely grips the skate blade in the skate sharpening machine, holding it during the sharpening process. The difficulty arises partly due to the short vertical height of the blade and the relative lack of area for a user to grasp the blade when loading it into the clamp. A user may pinch or otherwise injure his/her fingers when securing a loose skate blade to a blade clamp.

These challenges of loading a loose skate blade into the skate clamp are exacerbated when dealing with automated, vertical mount configuration skate sharpeners, including the sharpener unit 10 of FIG. 1. In these machines, the jaws that clamp the skate blade can be recessed, creating interference with the user's fingers when lowering the blade into the clamp. In some of these machines there also may not be any structure acting as a vertical (Z direction) stop for the blade. This lack of vertical stop increases the complexity of loading a loose blade, as the loose blade could be dropped into the enclosure of the skate sharpener. This might require that the sharpening machine be disassembled to retrieve the loose skate blade.

Additionally, the quality of the sharpening by a vertical mount machine can be affected by the vertical (Z-direction) location of the skate blade in the clamp. The vertical location of the skate blade can dictate the amount of force that will be applied to the skate blade by the grinding wheel. Thus, a user can negatively affect the quality of the skate sharpening by inserting a loose skate blade at an improper vertical position. A related aspect is the “pitch” of the blade, i.e., its rotational position about the Y axis. It is preferable for the blade to be substantially horizontal, so that proper contact and force exist between the grinding wheel and lower edge of the blade along its entire length. Improper rotational position can compromise these goals. When the blade of a complete skate is being sharpened, e.g. skate 150 of FIG. 6, there can be a beneficial contact between the bottom of the blade holder portion 154 and the clamp, serving to automatically locate the blade 152 at a desired Z-axis position and with desired Y-axis rotational position. This feature is absent when sharpening a loose skate blade.

Yet another challenge when loading a loose skate blade in existing blade clamp mechanisms is difficulty centering the skate blade in the X direction on the jaws of the clamp mechanism. This is due to the loose skate blade being less visible than a complete skate, and thus providing less of a visual cue that the skate blade is not centered. A non-centered skate blade can be problematic, because the blade may vibrate during sharpening if there is a long unsupported length outside of the clamp jaws. Such vibration would lower the quality of the sharpening. In the case of the vertical mount machines, a non-centered blade may cause the contact length for the grinding wheel to be altered in such a way that the skate blade is not sharpened along its entire length, or it may result in the grinding wheel changing its translation direction relative to the skate blade while still in contact with the skate blade, potentially damaging the blade.

Finally, most skate sharpening machines have a recommended X-direction orientation for securing the skate blade in the blade clamp, i.e., heel/toe direction relative to the machine. The proper heel/toe orientation of a loose skate blade may not be obvious to a user, as there is no skate boot to use as a reference. If a skate blade is loaded backwards in the clamp, the sharpener will operate differently than the manufacturer of the sharpener intended. This could result in a difference in the expected quality of the sharpening.

In summary, there are a number of challenges and problems associated with existing machines and techniques with respect to sharpening loose skate blades. These include:
1. The user can pinch their fingers in the clamp when holding the skate blade in place while securing it.
2. A gap can exist around the skate blade that gives users access to moving components in the sharpener. This gap would normally be covered by the blade holder portion and boot of a complete skate.
3. The skate blade could fall out of the clamp or have less retention force than needed on account of the skate blade being misaligned during installation. A misaligned skate blade could impact the quality of the sharpening as the skate blade may vibrate or move when the grinding wheel touches it during sharpening.
4. The skate blade could be dropped into a vertical mount sharpener enclosure.

5. The skate blade could be placed in an incorrect vertical location, non-centered (X-direction) location, incorrect y-axis rotation position, and/or incorrect heel/toe orientation, adversely affecting the quality of the sharpening.

There are known devices for holding loose skate blades, but not in connection with a sharpener unit such as the sharpener unit 10 of FIG. 1 which has both recessed clamping jaws 90 (FIG. 4) and the protective slot covers 28 that are meant to be engaged by the blade holder portion 154 of a complete skate. Known devices can neither place a loose skate blade 152 low enough nor provide the needed mechanical engagement with the bumpers 29 of the slot covers 28. Also, known holding devices do not address (either fully or at all) the problems of improper locating, centering and orienting as outlined above.

It is believed that a satisfactory solution for sharpening loose skate blades would have some or all the following features:
1. Rapid connection/disconnection to a loose skate blade of arbitrary size, while providing sufficient retention force to securely retain the skate blade
2. Keeping a user's hands at a safe distance when securing a loose skate blade to a blade clamp in a sharpener unit
3. Blocking the open area around a loose skate blade to guard against accidental contact with moving parts in the sharpener.
4. A profile to fit through a narrow opening at a top of a vertical mount machine place the skate blade down into a recessed blade clamp
5. Alignment features to assist a user with attaining proper depth, centering, y-axis rotation, and/or orientation (heel/toe)
6. Interface with safety switches in protective slot covers (e.g., in slot covers 28)

A good solution is also preferably of relatively simple and low-cost design and manufacture.

The above issues and goals are addressed by a blade holder tool as described herein. Several different embodiments are described, having most/all of the following desirable features:
1. Securely hold the skate blade, enabling accurate positioning and minimizing the risk of dropping the blade into a vertical-mount sharpener unit such as unit 10.
2. Slim profile that fits into the slot that receives the skate blade, and in some cases also fits between the clamping jaws to aid in locating and orienting the blade.
3. Alignment features that index the proper depth and y-axis rotation of the skate blade so that it is secured in the clamp at the desired vertical location.
4. Centering features that aid a user in placing the skate blade into the blade holder tool itself and into the clamp in a centered fashion.
5. Orientation features or markings that aid a user in placing the skate blade into the blade holder tool itself and into the clamp in the proper heel/toe orientation.
6. Features that engage with guards and/or safety switches of the sharpener unit, such as the slot covers 28 of unit 10, providing a safety interlock on operation

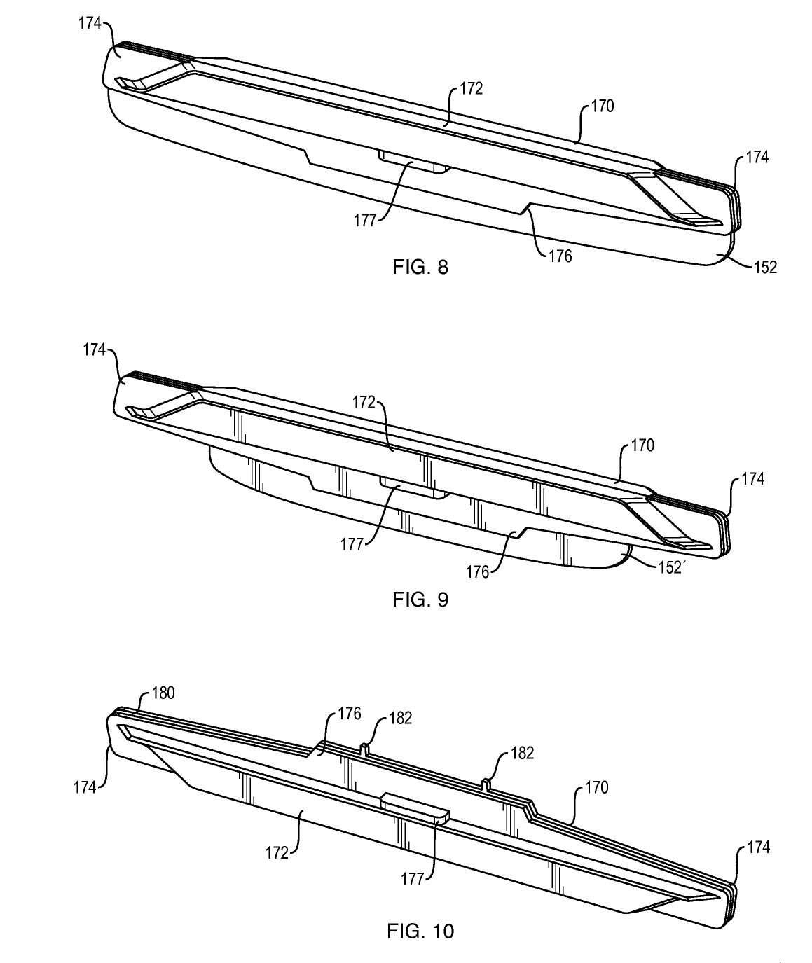

FIG. 8 shows a blade holder tool 170 holding a loose skate blade 152. The blade holder tool 170 is made of a generally stiff plastic material. It has a central portion 172 and endward portions 174. The central portion 172 is graspable by a user to enable the user to place the blade holder tool 170 in an inserted position while the blade holder tool 170 is holding the skate blade 152, thereby placing the skate blade 152 in a sharpening position where it is retained by the blade retention jaws 90 for sharpening, as described more below. A bottom portion 176 of the tool 170 receives the top of the skate blade 152. Also shown is a protrusion 177 referred to as a “jaw rest”, described more below. The endward portions 174 partially mimic the blade holder portion 154 of a complete skate, contacting the bumpers 29 of the slot covers 28 when the blade holder tool 170 is holding a clamped blade 152. As described more below, this contact trips or actuates the limit switches 138 of the slot covers 28. As also described more below, the blade holder tool 170 also blocks the open area of the slot 24 around the jaws 90 and skate blade 152 in the sharpening position to make sure a user's fingers cannot touch moving parts.

FIG. 8 shows the blade holder tool 170 holding a relatively long blade 152, as might be used by a large adult skater. Using a mechanism described below, the blade holder tool 170 is able to hold skate blades 152 of different lengths. FIG. 9 shows the blade holder tool 170 holding a much shorter blade 152, as might be used by a child skater.

FIG. 10 is a view of the underside of the blade holder tool 170. It has an outer tool body formed in a shell-like manner of two half-shells joined together, with separation at the bottom portion 176 to form a slot 180 that receives the skate blade 152. The slot 180 is sufficiently wide to accommodate a skate blade 152 of maximum thickness, which may be on the order of 0.12″. The skate blade 152 is retained by blade-engaging features within the body of the tool 170 as described more below. Also shown are a pair of protrusions 182 that serve to ensure proper heel/toe orientation of the tool 170 in the sharpener unit, as also described more below. In particular, the protrusions 182 form jaw interface features co-configured with cutouts of the jaws 90 (FIG. 4) to effect proper orientation.

In alternative embodiments, a different mechanical arrangement may be used to provide for properly orienting the blade holder tool 170 into the sharpener unit. In yet other embodiments, the blade holder tool 170 may not include such mechanical features. In an example described below, descriptive labels are used to provide guidance to the user as to proper orientation.

It is noted that the central portion 172 provides a sufficiently large area to enable a user to easily grip the blade holder tool 170 with his/her fingers. Also, because this portion 172 extends upwardly, the user's hand stays well above the top of the sharpener unit 10, away from the clamping and grinding components therein.

The blade holder tool 170 includes features for positioning and orienting the skate blade 152, which may include any/all of blade centering (X-axis location), blade vertical positioning (Z-axis location, blade rotational positioning (angle about Y axis), and blade heel/toe orientation. Proper blade rotational positioning ensures that the bottom edge of the skate blade 152 is substantially horizontal in the sharpening position, so that the grinding wheel contacts the bottom edge along its length with a desired amount of normal force (see FIG. 3). In the illustrated embodiment, this positioning and orienting are provided by the same blade-engaging features that hold the skate blade 152, although in alternative embodiments one or more of these positioning and/or orienting functions may be provided by separate features not directly involved in holding the skate blade 152.

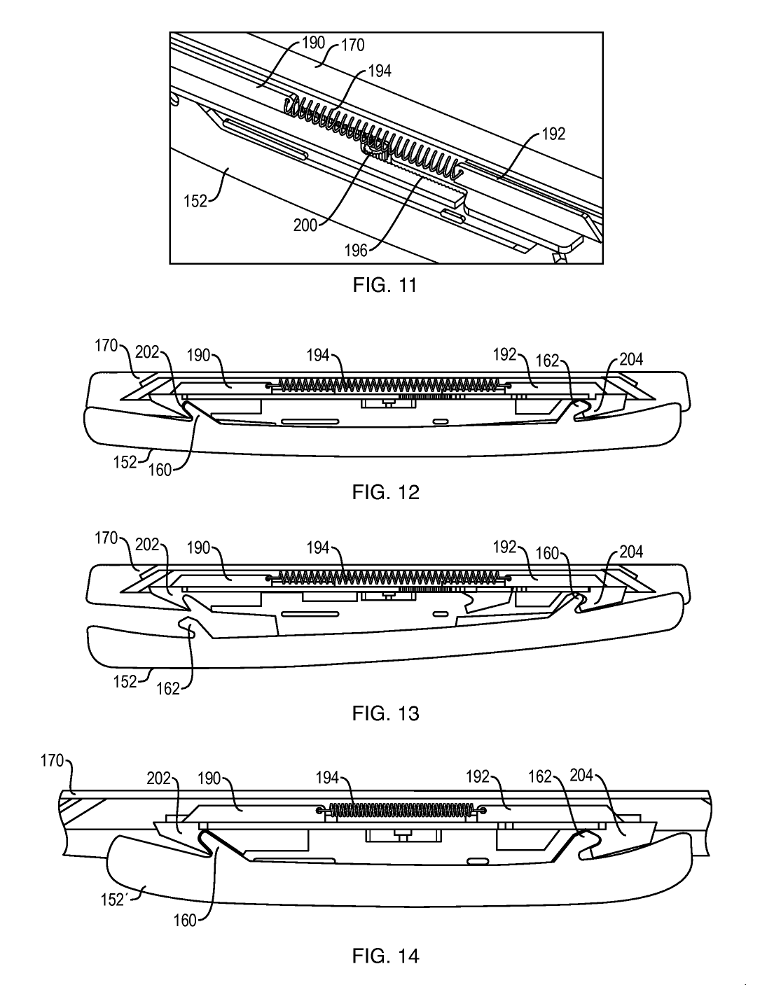

FIG. 11 shows the interior of the blade holder tool 170, including blade-engaging features that engage the protrusions 160, 162 of the skate blade 152 (FIG. 7) to hold the skate blade 152 to the tool 170. In particular, the tool 170 includes a pair of sliding members 190, 192 that are biased closed by action of a spring 194 connected in extension therebetween. The members 190, 192 have respective rack portions (rack portion 196 of member 190 visible) that engage opposite sides of a single rotating pinion gear 200 mounted to one of the half-shells of the tool body. This configuration causes the members 190, 192 to move symmetrically away from each other in response to a force applied to either of the members 190, 192 when a blade 152 is being inserted, and to move symmetrically toward each other by action of the spring 194 when a blade 152 is being removed.

FIG. 12 is a side view illustrating the members 190, 192 holding the skate blade 152 with proper X-axis (heel/toe) orientation. In particular, the members 190, 192 have respective catches 202, 204 that are shaped similar to the corresponding protrusions 160, 162 of the skate blade 152, so that the protrusions 160, 162 are fully captured by the respective catches 202, 204. The skate blade 152 has a desired horizontal orientation, i.e., its long axis is parallel to the axis of the tool 170.

FIG. 13 is a similar side view illustrating an attempt to load the skate blade 152 into the tool 170 with improper X-axis (heel/toe) orientation. The catch 202 does not receive the protrusion 162, so the left part of the blade 152 is not fully received into the tool 170. Not only is the blade 152 not retained, it also does not attain the desired horizontal orientation, i.e., its long axis is not parallel to the axis of the tool 170. A user can easily detect that the skate blade 152 is not being received by the tool 170 due to incorrect heel/toe orientation, enabling the user to rotate the blade to the proper orientation for installation as shown in FIG. 12.

A user installs or loads the blade 152 into the tool 170 by first inserting one of the protrusions 160, 162 into the respective catch 202, 204, pushing the blade 152 along its long axis to slide the members 190, 192 far enough apart so that the other protrusion can be accepted by the respective catch, and then releasing the pushing force to enable the spring 194 to bring the members 190, 192 toward each other, tightly capturing the protrusions 160, 162. A user removes the blade 152 by first pushing the blade 152 along its long axis to slide the members 190, 192 far enough apart so that one protrusion 160, 162 is released by the respective catch 202, 204, reducing the pushing force to enable the spring 194 to bring the members 190, 192 fully toward each other (i.e., to a limit of travel), and then removing the other protrusion from the respective catch.

As mentioned, in the illustrated embodiment the blade-engaging features provide for positioning and orienting the skate blade 152 as well as holding it. The sliding members 190, 192 have fixed Z-axis location and define the limit of upward blade insertion by their mechanical interference with the protrusions 160, 162, thus establishing Z-axis position of the blade 152. The members 190, 192 also move together and about a fixed center point and thus consistently locate the mid-point of the skate blade 152 at the fixed center point, irrespective of blade size. The catches 202, 204 fully engage the protrusions 160, 162 only when the skate blade 152 has the proper heel/toe orientation and horizontal attitude (Y-axis rotational position). In alternative embodiments, other features may be relied upon instead of or in addition to the blade-engaging features to establish one or more of the orientation and positioning. For example, there may be protrusions encountered by part(s) of the skate blade 152 that establish blade position, leaving the blade-engaging features to simply generate the forces for holding the skate blade 152 against the protrusions. Orientation may be established by other mechanical features that are asymmetric along the X-axis, making it possible to use blade-engaging features that are identical or at least symmetric in this direction.

FIG. 14 shows the tool 170 used with the shorter blade 152. For the shorter blade 152′, the protrusions 160, 162 are spaced apart by a correspondingly smaller spacing relative to the longer spacing of the long blade 152 showed in FIGS. 12 and 13. Thus the members 190, 192 attain a correspondingly smaller final spacing when fully engaging the protrusions 160, 162 as shown in FIG. 14. Thus it will be appreciated that the arrangement provides for variable or adjustable spacing of the members 190, 192 to accommodate blades 152 of different lengths. In a given embodiment the tool 170 may accommodate a large range of sizes, e.g., from child-size to adult-size. In other embodiments the range may be more limited. Tools 170 covering different size ranges, e.g., one for children's skates and another for adults′, may be used.

In the illustrated embodiment, variable spacing of the blade-engaging features is provided by a rack-and-pinion mechanism and a single spring extending between the members. This arrangement is only one example of a spacing component that can provide the desired variable spacing of the members. Those skilled in the art will understand that there may be many different approaches to providing these functions.

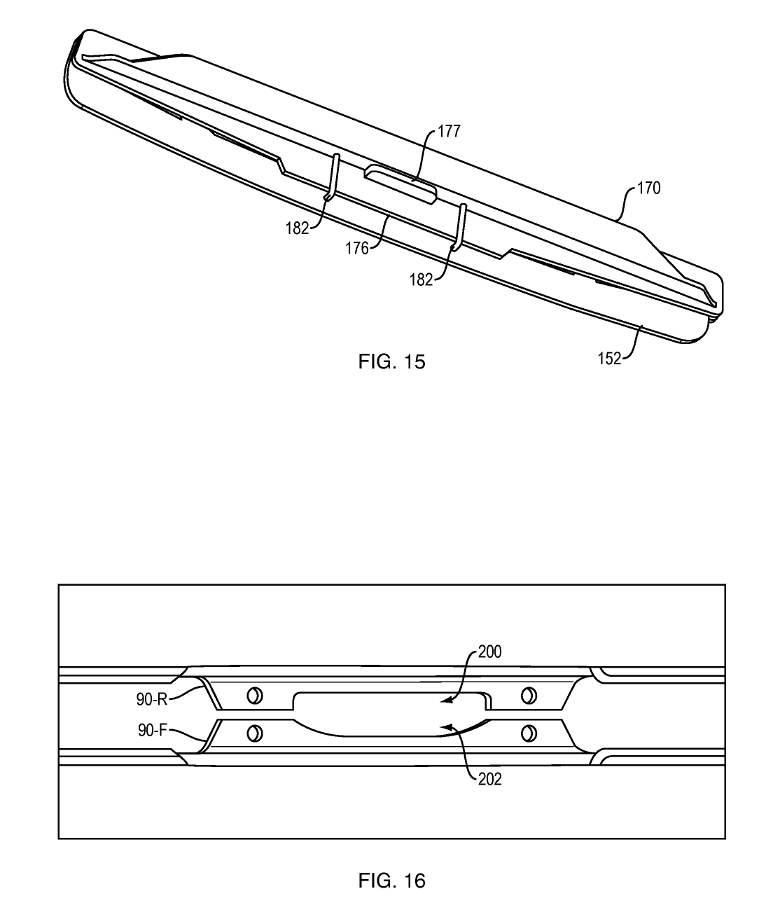

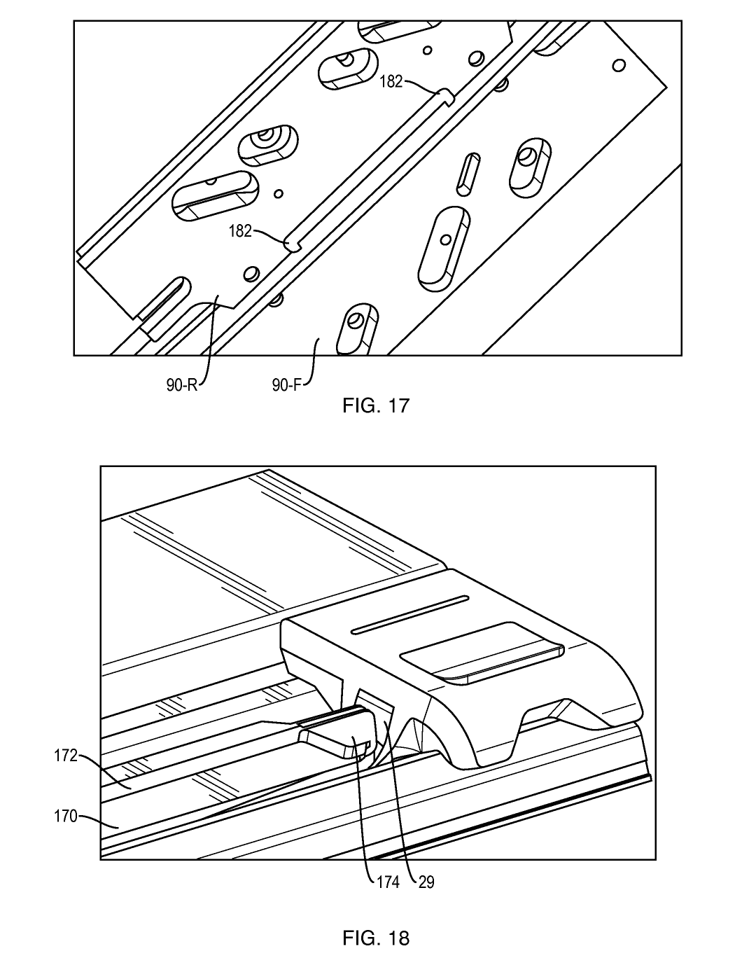

FIGS. 15 through 17 illustrate how proper heel/toe (X-axis) orientation is carried to the sharpener 10 in the illustrated embodiment. With the skate blade 152 properly oriented in the blade holder tool 170 as described above, it is necessary to ensure proper orientation of the blade holder tool 170 in the sharpener unit 10. Proper orientation is provided by the jaw interface feature of the tool 170 and corresponding features of the jaws 90 of the sharpener unit 10. The result is illustrated in FIG. 17, in which the blade holder tool 170 occupies an inserted position to locate the skate blade 152 in the proper sharpening position for sharpening.

As shown in FIG. 15, the jaw interface of the tool 170 includes the protrusions 182 as well as the jaw rests 177. The protrusions 182 are formed on only one side of the tool 170. The jaws 90 are designed so that even at their maximum separation they do not accommodate the rests 177, i.e., there is interference so that the rests 177 rest on top of the jaws 90 rather than entering the space between them.

FIG. 16 is a top-down view of the jaws 90 showing respective C-shaped cutouts 200, 202. The cutout 200 of the rear jaw 90-R has a squared shape, while the cutout 202 of the front jaw 90-F is more rounded as shown. Thus, the spaced-apart protrusions 182 can be received by the cutout 200 of the rear jaw 90-R but not by the cutout 202 of the front jaw 90-F. This provides for proper orientation of the blade holder tool 170, as the inability of the blade holder tool 170 to be received by the front jaw 90-F prevents the blade holder tool 170 from achieving a locked position as described more below.

FIG. 17 is a bottom-up view illustrating that the protrusions 182 are received by the cutout 200 of the rear jaw 90-R. Although not apparent in this view, it will be appreciated that with the blade holder tool 170 in this registered and locked position, also referred to as an inserted position, the jaw rests 177 (FIGS. 8 and 15) rest against the upper surfaces of the respective jaws 90-F, 90-R and the blade holder tool 170 cannot be moved in the X direction.

The above-described configuration provides tactile feedback to the user during insertion of the blade holder tool 170. When the blade holder tool 170 is oriented properly, the user can slide the blade holder tool 170 in the X direction until the spaced protrusions 182 become aligned with the cutout 200 of the rear jaw 90-R, at which point the blade holder tool 170 falls slightly in the Y direction toward the inside of the sharpener unit and becomes captured in the X direction. The user feels this movement and the feeling of the blade holder locking in place. Once this position has been achieved, the jaws 90 can be brought together to clamp the skate blade 152 firmly for sharpening. If the blade holder tool 170 is oriented incorrectly, it does not seat properly nor become captured in the X direction. Once a user is familiar with using the blade holder tool 170, the user will easily detect proper versus improper orientation.

FIG. 18 shows the blade holder tool 170 located in the in-use or inserted position, i.e., still attached to the top of a skate blade 152 (not visible) that is clamped in the sharpener unit 10 for sharpening. The lower, blade-engaging portion of the blade holder tool 170 extends downward into the slot 24 (FIG. 1) and toward the jaws 90 and grinding wheel when operating. The upper part 172 of the blade holder tool 170, which is held by a user when placing the blade holder tool 170 into position, extends upwardly, i.e., away from the retention jaws 90 and the grinding wheel. As shown, the slot cover 28 has been moved inwardly to a position in which the bumper 29 is slightly depressed by contacting the endward portion 174. In this position, the slot cover 28 covers a portion of the slot 24 that would otherwise be open. The depression of the bumper 29 actuates the limit switch 138 as described above with reference to FIG. 5. FIG. 18 shows only the configuration at the right slot cover 28, but it will be appreciated that a similar configuration is obtained at the left slot cover 28 as well, which covers a respective part of the slot 24 that would otherwise be open.

The blade holder tool 170 may be designed to fit any length skate blade while also providing the necessary features to engage the bumpers 29 of the slot covers 28. In other words, regardless of the length of the skate blade 152, the blade holder tool 170 connects to the blade and also provides the structure to interface with the slot covers 28. The blade holder tool 170 is of sufficient width so as to cover slot 24 fully along its length, while leaving the ends of the slot 24 to be covered by the slot covers 28. This full covering of the slot 28 enhances safety and proper operation by preventing introduction of foreign objects, including a user's fingers for example, into the slot 28 while the sharpener unit 10 is operating.

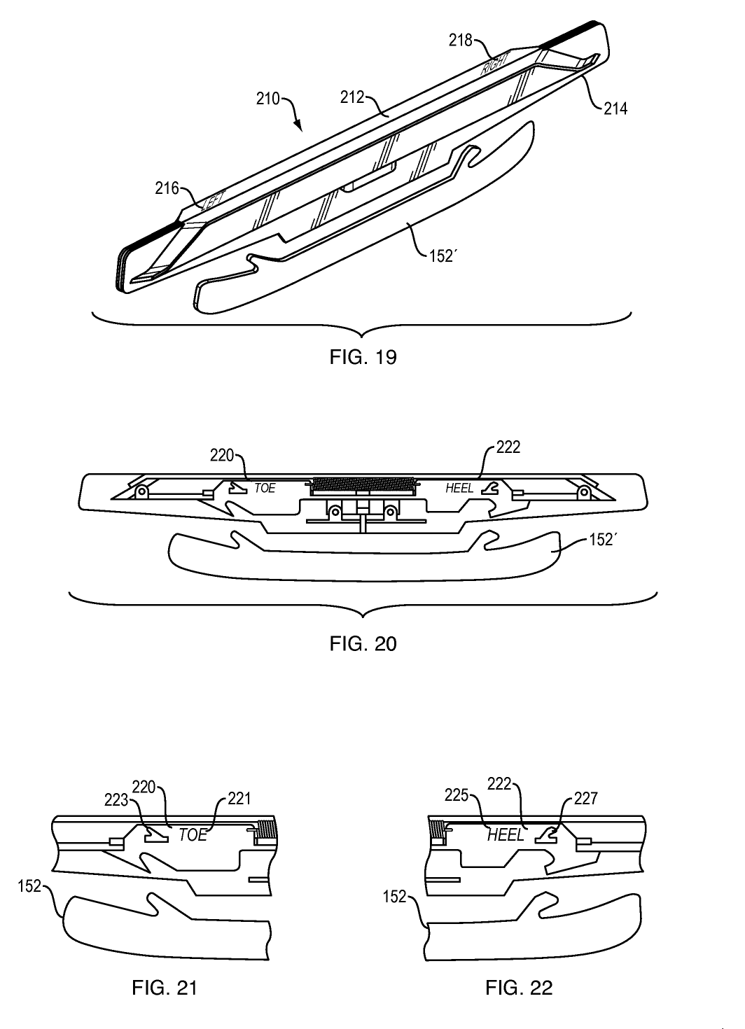

FIGS. 19-22 illustrate another embodiment of a skate blade holder tool. The blade holder tool 210 is generally similar to the tool 170 described above, and thus common features are not elaborated. Common features include the mechanism for retaining a skate blade 152, i.e., the sliding members 190, 192, a spacing component including pinion gear 200 and spring 194, etc. Certain differences are elaborated that relate to orienting the skate blade 172 in the blade holder tool 210 and orienting the blade holder tool 210 in the sharpener unit 10.

The blade holder tool 210 includes a shell-like body with shell halves 212, 214, and the shell half 214 is transparent to enable a user to see inside the tool 210. The tool 210 has labels 216, 218 indicating LEFT and RIGHT respectively and located at the left and right ends respectively of the tool 210. These labels indicate the correct orientation of the tool 210 with respect to the sharpener unit 10 as viewed in FIG. 1. A user orients the tool 210 with the LEFT label 216 at the left and the RIGHT label 218 at the right when inserting a blade 152 (short blade 152′ actually shown) being held by the tool 210 into the sharpener unit 10. Because the labels 216, 218 assist the user with correct orientation, there may be less need for tool-orienting mechanical features such as the protrusions 182 (FIGS. 10, 17). Such features are in fact omitted from the tool 210.

FIG. 20 and the close-ups of FIGS. 21 and 22 are side views showing that the sliding members 220, 222 include respective labels with text and graphical indicators for assisting with correct orientation of the skate blade 152 in the tool 210. The left member 220 includes the word TOE 221 and a graphic 223 of the protrusion 160 which should be inserted at this end. The right member 222 includes the word HEEL 225 and a graphic 227 of the protrusion 162 which should be inserted at this end. Larger views of the left and right areas are shown in FIGS. 21 and 22 respectively. As indicated above, the members 220, 222 and the respective graphics are user-visible through the transparent half-shell 214.

In an alternative embodiment, there may not be a transparent part such as the transparent half-shell 214. In such case the labels or other graphical indicators may be attached to or formed on the exterior of the opaque body of the tool.

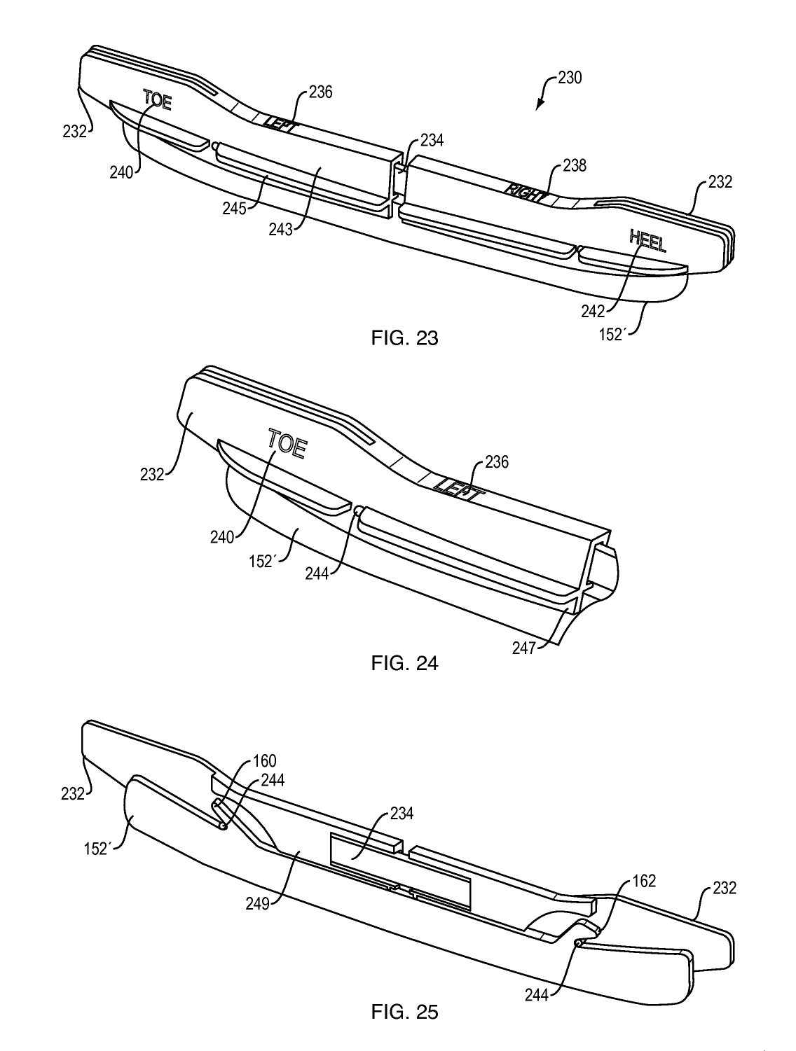

FIGS. 23-27 illustrate an alternative blade holder tool 230 having a different construction than the tool 170 described above. The tool 230 is formed of two blade-housing members (or simply “housing members”) 232 attached together by a spacing component in the form of an elastic member 234, examples of which are described below. The housing members 232 have respective narrow channels that receive respective end portions of a blade 152 (short blade 152′ shown), as well as blade-engaging features that capture the protrusions 160, 162 of the blade 152 to hold the blade 152 to the tool 230. The arrangement of the housing members 232 and elastic member 234 is analogous to the arrangement of the members 190, 192 and spring 194 of the tool 170 described above. The housing members 232 are biased toward each other so as to grasp the protrusions 160, 162 (FIG. 7) of the blade 152 with a grasping force. Additionally, the compliance of this arrangement enables variable spacing between the housing members 232 to accommodate blades 152 of different sizes (lengths).

FIG. 23 shows that the housing members 232 carry respective markings Left 236, Right 238, Toe 240 and Heel 242, which serve in the same manner as the markings 216, 218, 221 and 225 of the tool 170 as described above. The Left and Right markings 236, 238 help a user orient the tool 230 correctly in the sharpener 10, and the Toe and Heel markings 240, 242 help a user orient the blade 152, 152′ correctly in the tool 230. Apart from the markings, the housing members 232 may be of identical construction, although in alternative embodiments they may have mirror-image or other non-identical construction.

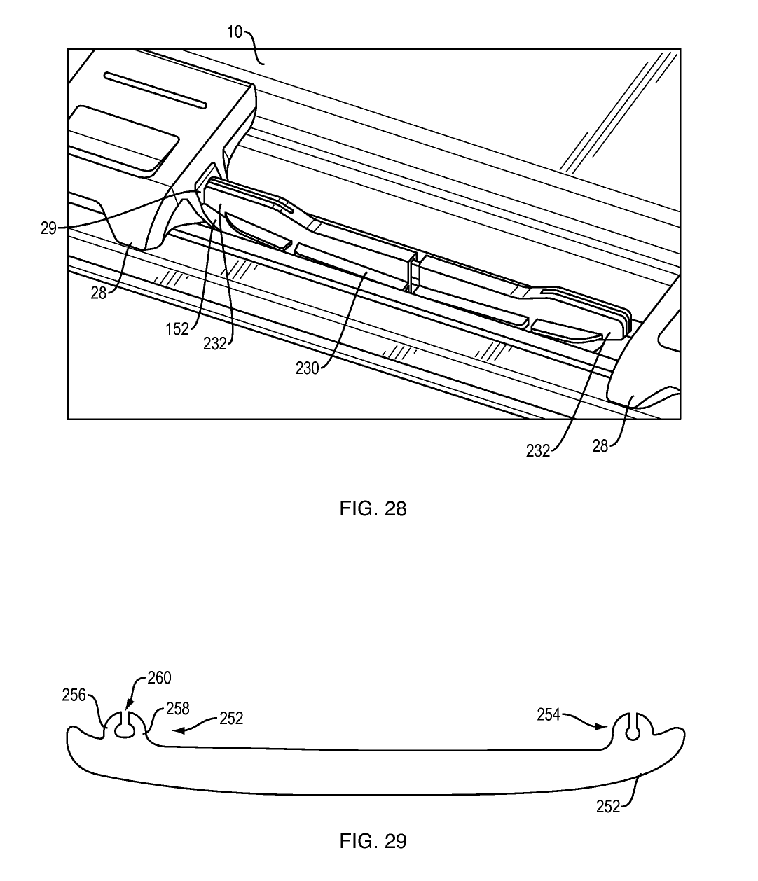

Also apparent in FIG. 23 is a certain cross-sectional shape of the each member 232, namely a relatively narrow central vertical portion 243 and lower flanges or horizontal portions 245 that extend outwardly to effectively widen the tool 230 at its bottom. The horizontal portions 245 serve to block corresponding parts of the entry slot 24 when the tool 230 is inserted in the sharpener 10, such as shown in FIG. 28 described below. From a design perspective, this arrangement decouples the cross-sectional width of the vertical portion 243, which is grasped by a user and thus preferably narrow, from the cross-sectional width at the location of the horizontal portions 245, which covers the entry slot 24 and therefore relatively wider. It may be desirable that the entry slot 24 be relatively wide to accommodate certain types of skates, such as some types of goalie skates. In that case the lower part 245 part of the tool 230 should be commensurately wide to completely cover the slot 24. The vertical portion 243 can be relatively narrow to be easily grasped by a user.

FIG. 24 is a close-up view of the left housing member 232 showing one end of a retention pin 244 that extends across the channel that receives the blade 152′. This can be seen in the section view of FIG. 25 in which one face of each housing member 232 is removed. With the blade 152′ installed as shown, each pin 244 rests in the crook of a respective protrusion 160, 162. Referring back to FIG. 24, the lower edge 247 of the housing member 232 rests on top of a respective retention jaw 90 when the tool 230 is inserted in the sharpener unit 10 in use.

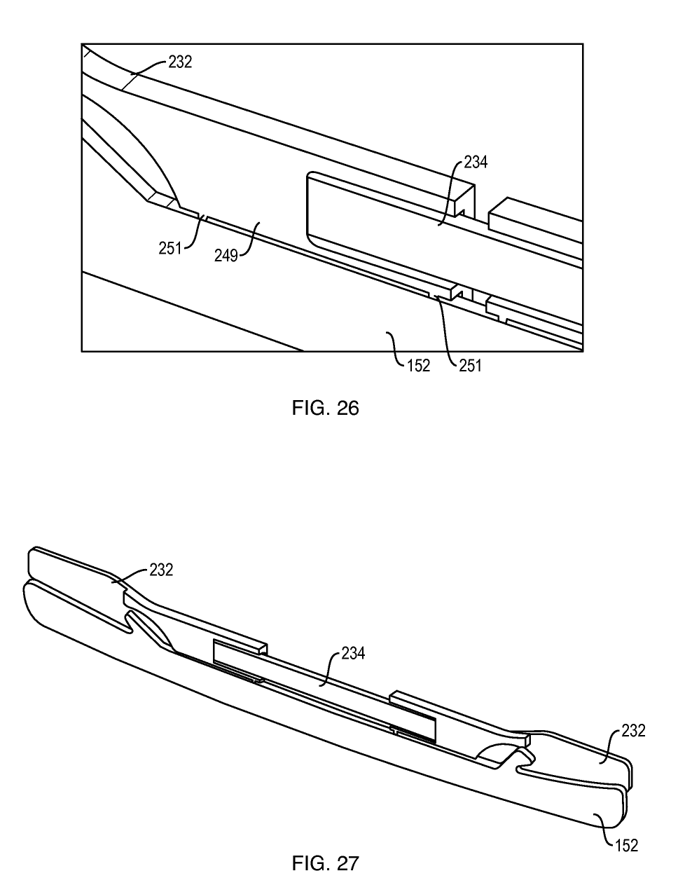

FIG. 25 also shows the elastic member 234 being secured to each member 232 in some manner such as by adhesive or other bonding. Also shown is an inner shoulder portion 249 serving as an X-axis reference, i.e., having a lower surface against which the upper edge of the blade 152 rests when fully inserted into the tool 230. More precisely, as shown in the close-up view of FIG. 26, the shoulder portion 249 may include small spaced-apart bumps 251 that contact the blade 152.

FIG. 27 illustrates use with the large blade 152. The housing members 232 are spaced further apart than shown in FIG. 23 and the elastic member 234 is stretched accordingly. The elastic member 234 may have any of a variety of constructions, e.g., one or more elastic bands, elastic or “bungee” cord(s), springs, etc.

FIG. 28 shows the tool 230 and blade 152 inserted into the sharpener unit 10. Similar to the arrangement of FIG. 18 described above, the housing members 232 depress the bumpers 29 of the respective slot covers 28 which have been slid inwardly to cover outer portions of the entry slot 24 (FIG. 1).

FIG. 29 shows an alternative loose blade 250 that employs slightly different blade retention features, in the form of protrusions 252, 254, than those of the blade 152. Each protrusion 252, 254 includes a pair of curved arms 256, 258 separated by a slot 260 at the top to define a receptacle that captures a corresponding pin, screw, or similar feature of the blade holder portion 154 (FIG. 6) of a skate in which the skate blade 250 is installed. The blade holder tool 230 may be used to hold the blade 250 by positioning the housing members 232 to bring the respective pins 244 into the receptacles of the respective protrusions 252, 258. The blade holder tool 230 may also be used with other skate blades, for example a blade having one retention feature similar to the feature 160 at the toe and another feature similar to feature 254 at the heel.

The following summarizes aspects of the present disclosure:

1. A blade holder tool for a user to hold a skate blade and insert the skate blade into a sharpener unit for a sharpening operation, the skate blade being a user-removable skate blade having retention features configured to engage a user-controlled blade retention mechanism of a skate to secure the skate blade in the skate, the retention features of the skate blade having a blade-size-specific spacing in a spacing range for skate blades across a range of blade sizes, comprising:

blade-engaging features configured to engage the retention features of the skate blade to hold the skate blade at a bottom portion of the blade holder tool; and

a spacing component configured to provide user-controlled variable spacing of the blade-engaging features across the spacing range to hold skate blades across the range of sizes.

2. A blade holder tool according to 1, wherein:

the skate blade is held by the sharpener unit in a sharpening position for the sharpening operation; and

the blade holder tool is configured to occupy an inserted position when holding the skate blade located in the sharpening position, and includes blade-locating features for correctly positioning the skate blade in the blade holder tool to ensure that the skate blade assumes the sharpening position when the blade holder tool is brought to the inserted position holding the skate blade.

3. A blade holder tool according to 2, wherein the sharpener unit has X, Y and Z axes aligned with respective axes of length, width and height of the skate blade in the sharpening position, the X-axis being an axis of heel/toe orientation of the skate blade in the sharpening position, and wherein the blade-locating features are configured to establish a predetermined correct heel/toe orientation of the skate blade when the blade holder tool occupies the inserted position holding the skate blade.

4. A blade holder tool according to 3, wherein the blade-locating features include graphical features configured to indicate to a user a correct orientation of the skate blade in the blade holder tool, the correct orientation corresponding to the correct heel/toe orientation of the skate blade in the sharpening position.

5. A blade holder tool according to 4, wherein the graphical features include respective graphical indicators for a toe end of the skate blade and a heel end of the skate blade at respective toe and heel locations of the blade holder tool.

6. A blade holder tool according to 5, wherein the blade holder tool has a transparent portion enabling a user to see an interior of the blade holder tool, and wherein the graphical indicators are disposed in the interior of the blade holder tool and visible to the user via the transparent portion.

7. A blade holder tool according to 6, wherein the transparent portion and interior are part of an elongated tool body supporting the blade-engaging features and spacing component.

8. A blade holder tool according to 5, wherein the graphical indicators are labels applied to a user-visible component of the blade holder tool.

9. A blade holder tool according to 3, wherein the blade-locating features are part of the blade-engaging features of the blade holder tool and locate the skate blade by mechanical interference with the retention features of the skate blade.

10. A blade holder tool according to 9, wherein the retention features of the skate blade are asymmetrically shaped with respect to each other, and the blade-engaging features are correspondingly shaped to engage the retention features when the skate blade has the correct heel/toe orientation and to not engage the retention features when the skate blade has an incorrect heel/toe orientation.

11. A blade holder tool according to 10, further including graphical blade-locating features configured to indicate to a user a correct orientation of the skate blade in the blade holder tool, the correct orientation corresponding to the correct heel/toe orientation of the skate blade in the sharpening position.

12. A blade holder tool according to 11, wherein the graphical features include respective graphical indicators for a toe end of the skate blade and a heel end of the skate blade at respective toe and heel locations of the blade holder tool.

13. A blade holder tool according to 12, wherein the blade holder tool has a transparent portion enabling a user to see an interior of the blade holder tool, and wherein the graphical indicators are disposed in the interior of the blade holder tool and visible to the user via the transparent portion.

14. A blade holder tool according to 12, wherein the graphical indicators are labels applied to a user-visible component of the blade holder tool.

15. A blade holder tool according to 2, wherein the sharpener unit has X, Y and Z axes aligned with respective axes of length, width and height of the skate blade in the sharpening position, and wherein the blade-locating features are configured to establish a predetermined X-axis location of the skate blade when the blade holder tool occupies the inserted position holding the skate blade.

16. A blade holder tool according to 15, wherein the blade-locating features are part of the blade-engaging features of the blade holder tool and locate the skate blade by mechanical interference with the retention features of the skate blade.

17. A blade holder tool according to 16, wherein the blade-engaging features move symmetrically in opposite X-axis directions about a center location to provide user-controlled variable spacing of the blade-engaging features.

18. A blade holder tool according to 17, further comprising an elongated tool body having a bottom portion configured to receive the skate blade to be held by the blade holder tool, and wherein the blade-engaging features and spacing component are supported by the tool body.

19. A blade holder tool according to 18, wherein the blade-engaging features include a pair of biased-closed sliding members having respective rack portions engaging a rotating pinion gear mounted to the tool body.

20. A blade holder tool according to 19, including a spring connected between the sliding members to bias closed the blade-engaging features relative to each other.

21. A blade holder tool according to 17, wherein the blade-engaging features include a pair of biased-closed housing members each engaging a respective one of the retention features of the skate blade.

22. A blade holder tool according to 21, including a spring connected between the housing members to bias closed the blade-engaging features relative to each other.

23. A blade holder tool according to 21, including an elastic member connected between the housing members to bias closed the blade-engaging features relative to each other.

24. A blade holder tool according to 2, wherein the sharpener unit has X, Y and Z axes aligned with respective axes of length, width and height of the skate blade in the sharpening position, and wherein the blade-locating features are configured to establish a predetermined Y-axis rotational position and a predetermined Z-axis location of the skate blade when the blade holder tool occupies the inserted position holding the skate blade.

25. A blade holder tool according to 24, wherein the blade-locating features are part of the blade-engaging features of the blade holder tool and locate the skate blade by mechanical interference with the retention features of the skate blade.

26. A blade holder tool according to 1, wherein:

the skate blade is held by the sharpener unit in a sharpening position for the sharpening operation; and

the blade holder tool is configured to occupy an inserted position when holding the skate blade located in the sharpening position, and includes tool-locating features for correctly positioning the blade holder tool in the sharpener unit in the inserted position.

27. A blade holder tool according to 26, wherein the sharpener unit has X, Y and Z axes aligned with respective axes of length, width and height of the skate blade in the sharpening position, the X-axis being an axis of heel/toe orientation of the skate blade in the sharpening position, and wherein the tool-locating features are mechanical features co-configured with mechanical features of the sharpener unit to establish a predetermined correct heel/toe orientation of the blade holder tool when occupying the inserted position holding the skate blade.

28. A blade holder tool according to 27, wherein the skate blade is held in the sharpening position by a pair of retention jaws at the opening of the sharpening unit, the retention jaws including the mechanical features of the sharpener unit

29. A blade holder tool according to 28, wherein the tool-locating features are co-configured with the mechanical features of the retention jaws in an asymmetric manner enabling the blade holder tool to assume only the correct orientation in the inserted position.

30. A blade holder tool according to 29, further including graphical features configured to indicate to a user the correct heel/toe orientation of the blade holder tool when occupying the inserted position holding the skate blade, the graphical features including respective graphical indicators for a left end of the blade holder tool and a right end of the blade holder tool as viewed by a user with the blade holder tool in the inserted position.

31. A blade holder tool according to 30, wherein the blade holder tool has a transparent portion enabling a user to see an interior of the blade holder tool, and wherein the graphical indicators are disposed in the interior of the blade holder tool and visible to the user via the transparent portion.

32. A blade holder tool according to 30, wherein the graphical indicators are labels applied to a user-visible component of the blade holder tool.

33. A blade holder tool according to 32, wherein the user-visible component of the blade holder tool is an elongated tool body having a bottom portion configured to receive the skate blade to be held by the blade holder tool, the tool body supporting the blade-engaging features and spacing component of the blade holder tool.

34. A blade holder tool according to 26, wherein the tool-locating features include graphical features configured to indicate to a user a correct left-to-right orientation of the blade holder tool in the sharpener unit, the correct left-to-right orientation corresponding to the correct heel/toe orientation of the skate blade in the sharpening position.

35. A blade holder tool according to 34, wherein the graphical features include respective graphical indicators for a left end of the blade holder tool and a right end of the blade holder tool as viewed by a user with the blade holder tool in the inserted position.

36. A blade holder tool according to 35, wherein the blade holder tool has a transparent portion enabling a user to see an interior of the blade holder tool, and wherein the graphical indicators are disposed in the interior of the blade holder tool and visible to the user via the transparent portion.

37. A blade holder tool according to 35, wherein the graphical indicators are labels applied to a user-visible component of the blade holder tool.

38. A blade holder tool according to 1, wherein the sharpener unit includes protective covers at respective ends of a blade-receiving opening of the sharpener unit.

39. A blade holder tool according to 38, shaped and sized to block a central portion of the blade-receiving opening of the sharpener unit when the blade holder tool occupies the inserted position.

40. A blade holder tool according to 39, further comprising an elongated tool body having a bottom portion configured to receive the skate blade to be held by the blade holder tool, the tool body supporting the blade-engaging features and spacing component of the blade holder tool, and wherein the tool body is configured to block the central portion of the blade-receiving opening.

41. A blade holder tool according to 39, wherein the blade-engaging features of the blade holder tool include a pair of biased-closed housing members each engaging a respective one of the retention features of the skate blade, and wherein the housing members are configured to block the central portion of the blade-receiving opening.

42. A blade holder tool according to 38, wherein the blade-receiving opening is an elongated entry slot.

43. A blade holder tool according to 38, wherein the protective covers include respective members.

44. A blade holder tool according to 43, wherein the blade holder tool has endward portions configured to engage the members of the protective covers when occupying an inserted position at the blade-receiving opening.

45. A blade holder tool according to 44, wherein the protective covers include sensors configured to be activated by the members when engaged by the endward portions of the blade holder tool, the sensors providing an indication of presence of the blade holder tool in the inserted position, the indication used by a controller of the sharpener unit to enable the sharpening operation.

46. A blade holder tool according to 1, further comprising an elongated tool body having a bottom portion configured to receive the skate blade to be held by the blade holder tool, and wherein the blade-engaging features and spacing component are supported by the tool body.

47. A blade holder tool according to 46, wherein the blade-engaging features move symmetrically in opposite axis directions about a center location to provide user-controlled variable spacing of the blade-engaging features.

48. A blade holder tool according to 47, wherein the blade-engaging features include a pair of biased-closed sliding members having respective rack portions engaging a rotating pinion gear mounted to the tool body.

49. A blade holder tool according to 48, including a spring connected between the sliding members to bias closed the blade-engaging features relative to each other.

50. A blade holder tool according to 1, wherein the blade-engaging features move symmetrically in opposite axis directions about a center location to provide user-controlled variable spacing of the blade-engaging features.

51. A blade holder tool according to 50, wherein the blade-engaging features include a pair of biased-closed housing members each engaging a respective one of the retention features of the skate blade.

52. A blade holder tool according to 51, including a spring connected between the housing members to bias closed the blade-engaging features relative to each other.

53. A blade holder tool according to 51, including an elastic member connected between the housing members to bias closed the blade-engaging features relative to each other.

54. A blade holder tool according to 1, wherein the blade-engaging features are configured to engage respective retention features of first and second types of skate blades, the first type of skate blade having retention features with end-facing openings, the second type of skate blade having retention features with upward-facing openings.

55. A blade holder tool according to 54, wherein the blade-engaging features include horizontal pins or posts being inserted by an inward motion into the retention features of the first type of skate blade and being inserted by a downward motion into the retention features of the second type of skate blade.

56. A skate blade sharpening system, comprising:
a sharpener unit configured to receive a skate blade for a sharpening operation; and
a blade holder tool for a user to hold the skate blade and insert the skate blade into the sharpener unit for the sharpening operation, the skate blade being a user-removable skate blade having retention features configured to engage a user-controlled blade retention mechanism of a skate to secure the skate blade in the skate, the retention features of the skate blade having a blade-size-specific spacing in a spacing range for skate blades across a range of blade sizes, the blade holder tool including (1) blade-engaging features configured to engage the retention features of the skate blade to hold the skate blade at a bottom portion of the blade holder tool, and (2) a spacing component configured to provide user-controlled variable spacing of the blade-engaging features across the spacing range to hold skate blades across the range of sizes.

57. A skate blade sharpening system according to 56, wherein:

the skate blade is held by the sharpener unit in a sharpening position for the sharpening operation; and

the blade holder tool is configured to occupy an inserted position when holding the skate blade located in the sharpening position, and includes tool-locating features for correctly positioning the blade holder tool in the sharpener unit in the inserted position.

58. A skate blade sharpening system according to 56, wherein:
the sharpener unit includes protective covers at respective ends of a blade-receiving opening of the sharpener unit; and
the tool body is shaped and sized to block a central portion of the blade-receiving opening of the sharpener unit when the blade holder tool occupies the inserted position.

59. A skate blade sharpening system according to 58, wherein:
the blade holder tool has endward portions configured to engage members of the protective covers when occupying an inserted position at the blade-receiving opening; and
the protective covers include sensors configured to be activated by the members when engaged by the endward portions of the blade holder tool, the sensors providing an indication of presence of the blade holder tool in the inserted position, the indication used by a controller of the sharpener unit to enable the sharpening operation.

60. A skate blade sharpening system according to 56, wherein the blade holder tool further includes an elongated tool body having a bottom portion configured to receive the skate blade to be held by the blade holder tool, and wherein the blade-engaging features and spacing component are supported by the tool body.

61. A skate blade sharpening system according to 56, wherein the blade-engaging features of the blade holder tool move symmetrically in opposite axis directions about a center location to provide user-controlled variable spacing of the blade-engaging features.

62. A skate blade sharpening system according to 61, wherein the blade-engaging features of the blade holder tool include a pair of biased-closed housing members each engaging a respective one of the retention features of the skate blade.

63. A skate blade sharpening system according to 62, wherein the blade holder tool includes an elastic member connected between the housing members to bias closed the blade-engaging features relative to each other.

While various embodiments of the invention have been particularly shown and described, it will be understood by those skilled in the art that various changes in form and details may be made therein without departing from the spirit and scope of the invention as defined by the appended claims.

1. A blade holder tool for a user to hold a skate blade and insert the skate blade into a sharpener unit for a sharpening operation, the skate blade being a user-removable skate blade having retention features configured to engage a user-controlled blade retention mechanism of a skate to secure the skate blade in the skate, the retention features of the skate blade having a blade-size-specific spacing in a spacing range for skate blades across a range of blade sizes, the blade holder tool comprising:
a first blade-engaging feature configured to engage a first retention feature of the skate blade positioned on a first side of the blade holder tool;
a second blade-engaging feature configured to engage a second retention feature of the skate blade positioned on a second side of the blade holder tool;
the first blade engaging feature configured to move toward the second blade-engaging feature and the second blade-engaging feature configured to move toward the first blade-engaging feature such that the first blade-engaging feature engages the first retention feature and the second blade-engaging feature engages the second retention feature to hold the skate blade at a bottom portion of the blade holder tool; and
a spacing component configured to provide user-controlled variable spacing of the first and second blade-engaging features across the spacing range to hold skate blades across the range of sizes.

2. A blade holder tool according to claim 1, wherein
the blade holder tool includes blade-locating features for correctly positioning the skate blade in the blade holder tool to ensure that the skate blade is correctly positioned in a sharpening position for a sharpening operation when the blade holder tool is in an inserted position holding the skate blade within the sharpening unit.

3. A blade holder tool according to claim 2, wherein the sharpener unit has X, Y and Z axes aligned with respective axes of length, width and height of the skate blade in the sharpening position, the X-axis being an axis of heel/toe orientation of the skate blade in the sharpening position, and wherein the blade-locating features are configured to establish a predetermined correct heel/toe orientation of the skate blade when the blade holder tool occupies the inserted position holding the skate blade.

4. A blade holder tool according to claim 3, wherein the blade-locating features include graphical features configured to indicate to a user a correct orientation of the skate blade in the blade holder tool, the correct orientation corresponding to the correct heel/toe orientation of the skate blade in the sharpening position.

5. A blade holder tool according to claim 4, wherein the graphical features include respective graphical indicators for a toe end of the skate blade and a heel end of the skate blade at respective toe and heel locations of the blade holder tool.

6. A blade holder tool according to claim 3, wherein the blade-locating features are part of the blade-engaging features of the blade holder tool and locate the skate blade by mechanical interference with the retention features of the skate blade.

7. A blade holder tool according to claim 2, wherein the sharpener unit has X, Y and Z axes aligned with respective axes of length, width and height of the skate blade in the sharpening position, and wherein the blade-locating features are configured to establish a predetermined X-axis location of the skate blade when the blade holder tool occupies the inserted position holding the skate blade, the X-axis being an axis of heel/toe orientation of the skate blade in the sharpening position.

8. A blade holder tool according to claim 7, wherein the blade-locating features are part of the blade-engaging features of the blade holder tool and locate the skate blade by mechanical interference with the retention features of the skate blade.

9. A blade holder tool according to claim 8, wherein the blade-engaging features move symmetrically in opposite X-axis directions about a center location to provide user-controlled variable spacing of the blade-engaging features.

10. A blade holder tool according to claim 9, wherein the blade-engaging features include a pair of biased-closed housing members each engaging a respective one of the retention features of the skate blade.

11. A blade holder tool according to claim 10, including an elastic member connected between the housing members to bias closed the blade-engaging features relative to each other.

12. A blade holder tool according to claim 2, wherein the sharpener unit has X, Y and Z axes aligned with respective axes of length, width and height of the skate blade in the sharpening position, and wherein the blade-locating features are configured to establish a predetermined Y-axis rotational position and a predetermined Z-axis location of the skate blade when the blade holder tool occupies the inserted position holding the skate blade.

13. A blade holder tool according to claim 12, wherein the blade-locating features are part of the blade-engaging features of the blade holder tool and locate the skate blade by mechanical interference with the retention features of the skate blade.

14. A blade holder tool according to claim 1, wherein
the blade holder tool includes tool-locating features for correctly positioning the blade holder tool in the sharpener unit when the blade holder tool is in an inserted position, wherein in the inserted position the skate blade is held by the sharpener unit in a sharpening position for the sharpening operation.

15. A blade holder tool according to claim 14, wherein the sharpener unit has X, Y and Z axes aligned with respective axes of length, width and height of the skate blade in the sharpening position, the X-axis being an axis of heel/toe orientation of the skate blade in the sharpening position, and wherein the tool-locating features are mechanical features co-configured with mechanical features of the sharpener unit to establish a predetermined correct heel/toe orientation of the blade holder tool when occupying the inserted position holding the skate blade.

16. (canceled)

17. A blade holder tool according to claim 15, wherein the tool-locating features include graphical features configured to indicate to a user a correct left-to-right orientation of the blade holder tool in the sharpener unit, the correct left-to-right orientation corresponding to the correct heel/toe orientation of the skate blade in the sharpening position.

18. A blade holder tool according to claim 17, wherein the graphical features include respective graphical indicators for a left end of the blade holder tool and a right end of the blade holder tool as viewed by a user with the blade holder tool in the inserted position.

19. (canceled)

20. A blade holder tool according to claim 17, shaped and sized to block a central portion of the blade-receiving opening of the sharpener unit when the blade holder tool occupies the inserted position.

21. A blade holder tool according to claim 20, wherein the blade-engaging features of the blade holder tool include a pair of biased-closed housing members each engaging a respective one of the retention features of the skate blade, and wherein the housing members are configured to block the central portion of the blade-receiving opening.

22. (canceled)

23. (canceled)

24. A blade holder tool according to claim 1, wherein the blade holder tool has endward portions configured to engage members of protective covers of the sharpener unit when occupying an inserted position at a blade-receiving opening of the sharpener unit.

25. A blade holder tool according to claim 24, wherein the protective covers include sensors configured to be activated by the members when engaged by the endward portions of the blade holder tool, the sensors providing an indication of presence of the blade holder tool in the inserted position, the indication used by a controller of the sharpener unit to enable the sharpening operation.

26. A blade holder tool according to claim 1, wherein the first and second blade-engaging features move symmetrically in opposite axis directions about a center location to provide user-controlled variable spacing of the blade-engaging features.

27. A blade holder tool according to claim 26, wherein the first and second blade-engaging features include each include a biased-closed housing member.

28. A blade holder tool according to claim 27, including an elastic member connected between the housing members to bias closed the first and second blade-engaging features relative to each other.

29. A blade holder tool according to claim 1, wherein the first and second blade-engaging features are configured to engage respective retention features of first and second types of skate blades, the first type of skate blade having retention features with end-facing openings, the second type of skate blade having retention features with upward-facing openings.

30. A blade holder tool according to claim 29, wherein the first and second blade-engaging features include horizontal pins or posts being inserted by an inward motion into the retention features of the first type of skate blade and being inserted by a downward motion into the retention features of the second type of skate blade.
